(19) United States
(12) Patent Application Publication
(10) Pub. No.: US 2025/0334853 A1
(43) Pub. Date: Oct. 30, 2025

(54) SENSOR SHIFT FOR OPTICAL IMAGE STABILIZATION AND FOCUSING IN COMPACT CAMERA DEVICES

(71) Applicant: Meta Platforms Technologies, LLC, Menlo Park, CA (US)

(72) Inventors: Gue Hyung Kwon, San Jose, CA (US); Yizhi Xiong, Foster City, CA (US)

(21) Appl. No.: 18/112,137

(22) Filed: Feb. 21, 2023

Related U.S. Application Data
(60) Provisional application No. 63/312,629, filed on Feb. 22, 2022.

(51) Int. Cl. G03B 5/04; G03B 13/36; G03B 30/00

(52) U.S. Cl. CPC G03B 5/04; G03B 13/36; G03B 30/00; G03B 2205/0015; G03B 2205/0069

(57) ABSTRACT

A camera device with optical image stabilization and focusing functionalities. The camera device includes a lens assembly positioned along an optical axis, a magnetic assembly with a plurality of magnets that produce a magnetic field, and a platform comprising a plurality of stabilization coils, a plurality of focusing coils, and a sensor. The platform can move the sensor in one or more directions relative to the optical axis. Each stabilization coil is aligned to a first side of a respective magnet and supplied with respective first current that interacts with the magnetic field causing the sensor to translate in a direction orthogonal to the optical axis. Each focusing coil is aligned to a second side of the respective magnet and supplied with respective second current that interacts with the magnetic field causing the sensor to translate towards or away from the lens assembly.

### CROSS REFERENCE TO RELATED APPLICATIONS

This application claims a priority and benefit to U.S. Provisional Patent Application Ser. No. 63/312,629, filed Feb. 22, 2022, which is hereby incorporated by reference in its entirety.

### FIELD OF THE INVENTION

The present disclosure relates generally to compact camera devices, and specifically relates to sensor shift for optical image stabilization and focusing in compact camera devices.

### BACKGROUND

Conventional cameras typically include optical image stabilization (OIS) and auto focusing (AF) based on a movement of a camera lens. The OIS and AF typically employ one or more magnets and coils to stabilize and locate the camera lens relative to an image sensor. To improve low light performance, one can increase unit pixel size of the image sensor and/or reduce the lens F number. However, these changes can increase a moving weight for OIS and AF due to an enlarged lens diameter corresponding to a sensor dimension and additional lens elements needed to meet similar optic performance for low F number optics and a bigger magnet dimension. A conventional lens-shift camera with a voice coil motor (VCM) has limitations to move heavy weights that consume a substantial power to keep same performance and weak mechanical scheme to hold entire moving parts. Specially, heavy moving parts cannot be sustained by the conventional suspension wire because one or more weak VCM components are damaged easily. Other small geometry motors do solve this issue with the conventional lens-shift camera, but they need more space to feed to the camera system. Therefore, these motors are difficult to implement in small form-factor camera devices. Moreover, conventional camera systems with a moving auto focusing lens cannot seal fully to prevent particle ingress into a camera device because there is a space between a lens carrier and a shield can of the camera device.

### SUMMARY

Embodiments of the present disclosure relate to a camera device (e.g., wearable camera device) with optical image stabilization and focusing (e.g., auto focus) based on shifting of a sensor of the camera device. The camera device includes a lens assembly fixed in place to a lens holder and positioned along an optical axis, a magnetic assembly including a plurality of magnets that produce a magnetic field, and a platform that includes a plurality of stabilization coils, a plurality of focusing coils, and the sensor that is configured to detect light from the lens assembly. The platform is configured to move the sensor in one or more directions relative to the optical axis. Each stabilization coil of the plurality of stabilization coils is aligned to a first side of a respective magnet of the plurality of magnets and supplied with respective first current that interacts with the magnetic field causing the sensor to translate in one or more directions orthogonal to the optical axis. Each focusing coil of the plurality of focusing coils is aligned to a second side of the respective magnet and supplied with respective second current that interacts with the magnetic field causing the sensor to translate towards or away from the lens assembly (e.g., parallel to the optical axis).

The camera device presented herein may be part of a wristband system, e.g., a smartwatch or some other electronic wearable device. Additionally or alternatively, the camera device may be part of a handheld electronic device (e.g., smartphone) or some other portable electronic device.

### BRIEF DESCRIPTION OF THE DRAWINGS

FIG. 1A is a top view of an example wristband system, in accordance with one or more embodiments.

FIG. 1B is a side view of the example wristband system of FIG. 1A.

FIG. 2A is a perspective view of another example wristband system, in accordance with one or more embodiments.

FIG. 2B is a perspective view of the example wristband system of FIG. 2A with a watch body released from a watch band, in accordance with one or more embodiments.

FIG. 3A is a cross section of a camera device in an upward (vertical) posture, in accordance with one or more embodiments.

FIG. 3B is a cross section of an optical image stabilization (OIS) assembly of the camera device in FIG. 3A, in accordance with one or more embodiments.

FIG. 3C is a cross section of a focusing assembly of the camera device in FIG. 3A, in accordance with one or more embodiments.

FIG. 3D is a cross section of a base assembly of the camera device in FIG. 3A, in accordance with one or more embodiments.

FIG. 4 illustrates an example process of assembling the OIS assembly of FIG. 3B, in accordance with one or more embodiments.

FIG. 5 illustrates an example process of assembling the focusing assembly of FIG. 3C, in accordance with one or more embodiments.

FIG. 6 illustrates an example process of assembling the base assembly of FIG. 3D, in accordance with one or more embodiments.

FIG. 7 illustrates an example process of assembling a platform in the camera device of FIG. 3A, in accordance with one or more embodiments.

FIG. 8 illustrates an example process of assembling a lens assembly to a platform in the camera device of FIG. 3A, in accordance with one or more embodiments.

FIG. 9 illustrates an example process of attaching a stiffener to a base in the camera device of FIG. 3A, in accordance with one or more embodiments.

FIG. 10 is a flowchart illustrating a process of initiating movement of a sensor at a camera device for OIS and focusing, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments of the present disclosure relate to a camera device (e.g., wearable camera device) with an optical image stabilization (OIS) and auto focusing (AF) capabilities based on translation of a sensor of the camera device. The camera device may thus include both an OIS assembly and a focusing assembly. The approach for OIS and focusing presented herein can provide an improved tradeoff between a size of the OIS assembly, a size of the focusing assembly, and performance of the camera device. Components of the OIS assembly and the focusing assembly may have a smaller footprint, an improved dynamics of the camera device can be achieved, as well as a reduced power consumption at the camera device.

A camera device is described herein that shifts a location of the sensor to provide both focusing functionality (e.g., AF functionality) and OIS functionality. The camera device is compact, and may be part of a smartwatch, headset, etc.

The main objective may be to compensate blur in an image taken by the camera device introduced due to a hand motion (including rotation about x axis) occurring while the image is being taken (i.e., during an exposure of the camera device). To reduce a level of blur in the image taken by the camera device, OIS and/or focusing may be applied (e.g., by the OIS assembly and/or the auto focus assembly). For example, movement (which may include rotation) of an optical axis during an exposure of the camera device may introduce shift in projection point at a sensor of the camera device, which causes that a blurred image is produced. The camera device may rotate around at least one axis (e.g., x axis) when changing orientation from a first orientation (e.g., upward, or vertical posture) to a second orientation (e.g., forward, or horizontal posture) during the exposure.

The blur can be reduced (i.e., completely avoided or mitigated below a threshold level) by shifting a sensor of the camera device, i.e., by applying stroke(s) of the sensor initiated by the OIS assembly and/or the focusing assembly. The amount of shift (i.e., stroke) of the sensor may be a function of focal length of the lens assembly and/or a rotation angle. Longer exposures of the camera device may require a longer stroke to sufficiently reduce blur in an image being taken by the camera device. The OIS assembly and/or the focusing assembly may initiate a motion (shifting) of the sensor responsive to the camera device changing orientation from the first orientation to the second orientation during the exposure.

The camera device may be incorporated into a small form factor electronic device, such as an electronic wearable device. Examples of electronic wearable devices include a smartwatch or a head-mount display (HMD). The electronic device can include other components (e.g., haptic devices, speakers, etc.). And, the small form factor of the electronic device provides limited space between the other components and the camera device. In some embodiments, the electronic device may have limited power supply (e.g., due to being dependent on a re-chargeable battery).

In some embodiments, the electronic wearable device may operate in an artificial reality environment (e.g., a virtual reality environment). The camera device of the electronic wearable device may be used to enhance an artificial reality application running on an artificial reality system (e.g., running on an HMD device worn by the user). The camera device may be disposed on multiple surfaces of the electronic wearable device such that data from a local area, e.g., surrounding a wrist of the user, may be captured in multiple directions. For example, one or more images may be captured describing the local area and the images may be sent and processed by the HMD prior to be presented to the user.

Embodiments of the present disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including an electronic wearable device (e.g., headset) connected to a host computer system, a standalone electronic wearable device (e.g., headset, smartwatch, bracelet, etc.), a mobile device or computing system, or any other hardware platform capable of providing artificial reality content to one or more viewers.

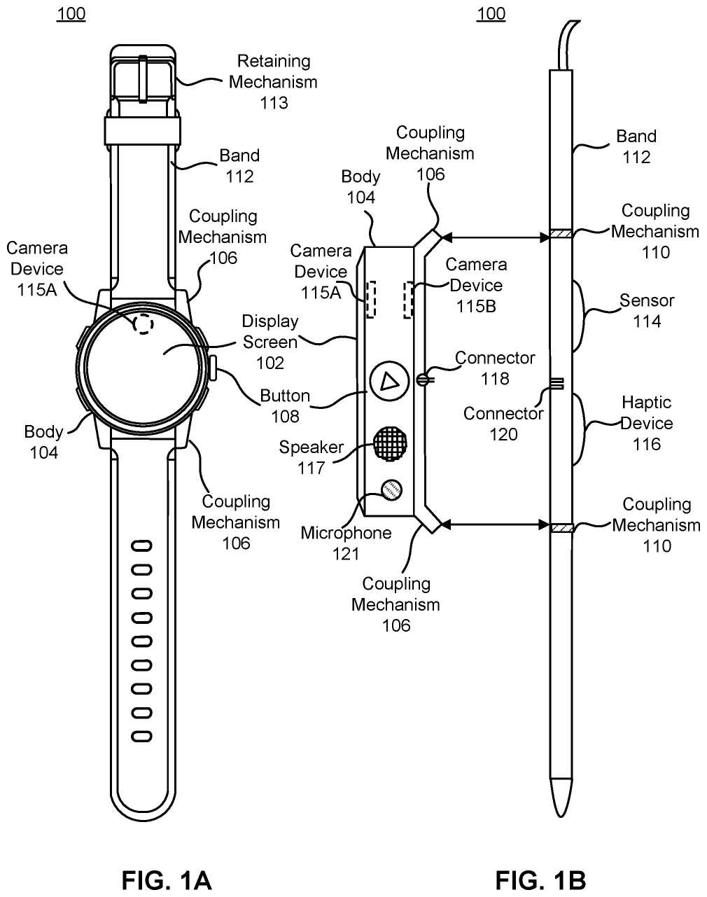

FIG. 1A is a top view of an example wristband system 100, in accordance with one or more embodiments. FIG. 1B is a side view of the example wristband system 100 of FIG. 1A. The wristband system 100 is an electronic wearable device and may be worn on a wrist or an arm of a user. In some embodiments, the wristband system 100 is a smartwatch. Media content may be presented to the user wearing the wristband system 100 using a display screen 102 and/or one or more speakers 117. However, the wristband system 100 may also be used such that media content is presented to a user in a different manner (e.g., via touch utilizing a haptic device 116). Examples of media content presented by the wristband system 100 include one or more images, video, audio, or some combination thereof. The wristband system 100 may operate in an artificial reality environment (e.g., a VR environment, an AR environment, a MR environment, or some combination thereof).

In some examples, the wristband system 100 may include multiple electronic devices (not shown) including, without limitation, a smartphone, a server, a head-mounted display (HMD), a laptop computer, a desktop computer, a gaming system, Internet of things devices, etc. Such electronic devices may communicate with the wristband system 100 (e.g., via a personal area network). The wristband system 100 may have sufficient processing capabilities (e.g., central processing unit (CPU), memory, bandwidth, battery power, etc.) to offload computing tasks from each of the multiple electronic devices to the wristband system 100. Additionally, or alternatively, each of the multiple electronic devices may have sufficient processing capabilities (e.g., CPU, memory, bandwidth, battery power, etc.) to offload computing tasks from the wristband system 100 to the electronic device(s).

The wristband system 100 includes a watch body 104 coupled to a watch band 112 via one or more coupling mechanisms 106, 110. The watch body 104 may include, among other components, one or more coupling mechanisms 106, one or more camera devices 115 (e.g., camera device 115A and 115B), the display screen 102, a button 108, a connector 118, a speaker 117, and a microphone 121. The watch band 112 may include, among other components, one or more coupling mechanisms 110, a retaining mechanism 113, one or more sensors 114, the haptic device 116, and a connector 120. While FIGS. 1A and 1B illustrate the components of the wristband system 100 in example locations on the wristband system 100, the components may be located elsewhere on the wristband system 100, on a peripheral electronic device paired with the wristband system 100, or some combination thereof. Similarly, there may be more or fewer components on the wristband system 100 than what is shown in FIGS. 1A and 1B. For example, in some embodiments, the watch body 104 may include a port for connecting the wristband system 100 to a peripheral electronic device and/or to a power source. The port may enable charging of a battery of the wristband system 100 and/or communication between the wristband system 100 and a peripheral device. In another example, the watch body 104 may include an inertial measurement unit (IMU) that measures a change in position, an orientation, and/or an acceleration of the wristband system 100. The IMU may include one or more sensors, such as one or more accelerometers, one or more gyroscopes, one or more magnetometers, another suitable type of sensor that detects motion, a type of sensor used for error correction of the IMU, or some combination thereof.

The watch body 104 and the watch band 112 may have any size and/or shape that is configured to allow a user to wear the wristband system 100 on a body part (e.g., a wrist). The wristband system 100 may include the retaining mechanism 113 (e.g., a buckle) for securing the watch band 112 to the wrist of the user. The coupling mechanism 106 of the watch body 104 and the coupling mechanism 110 of the watch band 112 may attach the watch body 104 to the watch band 112. For example, the coupling mechanism 106 may couple with the coupling mechanism 110 by sticking to, attaching to, fastening to, affixing to, some other suitable means for coupling to, or some combination thereof.

The wristband system 100 may perform various functions associated with the user. The functions may be executed independently in the watch body 104, independently in the watch band 112, and/or in communication between the watch body 104 and the watch band 112. In some embodiments, a user may select a function by interacting with the button 108 (e.g., by pushing, turning, etc.). In some embodiments, a user may select a function by interacting with the display screen 102. For example, the display screen 102 is a touchscreen and the user may select a particular function by touching the display screen 102. The functions executed by the wristband system 100 may include, without limitation, displaying visual content to the user (e.g., displaying visual content on the display screen 102), presenting audio content to the user (e.g., presenting audio content via the speaker 117), sensing user input (e.g., sensing a touch of button 108, sensing biometric data with the one or more sensors 114, sensing neuromuscular signals with the one or more sensors 114, etc.), capturing audio content (e.g., capturing audio with microphone 121), capturing data describing a local area (e.g., with a front-facing camera device 115A and/or a rear-facing camera device 115B), communicating wirelessly (e.g., via cellular, near field, Wi-Fi, personal area network, etc.), communicating via wire (e.g., via the port), determining location (e.g., sensing position data with a sensor 114), determining a change in position (e.g., sensing change(s) in position with an IMU), determining an orientation and/or acceleration (e.g., sensing orientation and/or acceleration data with an IMU), providing haptic feedback (e.g., with the haptic device 116), etc.

The display screen 102 may display visual content to the user. The displayed visual content may be oriented to the eye gaze of the user such that the content is easily viewed by the user. Traditional displays on wristband systems may orient the visual content in a static manner such that when a user moves or rotates the wristband system, the content may remain in the same position relative to the wristband system causing difficulty for the user to view the content. The displayed visual content may be oriented (e.g., rotated, flipped, stretched, etc.) such that the displayed content remains in substantially the same orientation relative to the eye gaze of the user (e.g., the direction in which the user is looking). The displayed visual content may also be modified based on the eye gaze of the user. For example, in order to reduce the power consumption of the wristband system 100, the display screen 102 may dim the brightness of the displayed visual content, pause the displaying of visual content, or power down the display screen 102 when it is determined that the user is not looking at the display screen 102. In some examples, one or more sensors 114 of the wristband system 100 may determine an orientation of the display screen 102 relative to an eye gaze direction of the user.

The position, orientation, and/or motion of eyes of the user may be measured in a variety of ways, including through the use of optical-based eye-tracking techniques, infrared- based eye-tracking techniques, etc. For example, the front-facing camera device 115A and/or rear-facing camera device 115B may capture data (e.g., visible light, infrared light, etc.) of the local area surrounding the wristband system 100 including the eyes of the user. The captured data may be processed by a controller (not shown) internal to the wristband system 100, a controller external to and in communication with the wristband system 100 (e.g., a controller of an HMD), or a combination thereof to determine the eye gaze direction of the user. The display screen 102 may receive the determined eye gaze direction and orient the displayed content based on the eye gaze direction of the user.

In some embodiments, the watch body 104 may be communicatively coupled to an HMD. The front-facing camera device 115A and/or the rear-facing camera device 115B may capture data describing the local area, such as one or more wide-angle images of the local area surrounding the front-facing camera device 115A and/or the rear-facing camera device 115B. The wide-angle images may include hemispherical images (e.g., at least hemispherical, substantially spherical, etc.), 180-degree images, 360-degree area images, panoramic images, ultra-wide area images, or a combination thereof. In some examples, the front-facing camera device 115A and/or the rear-facing camera device 115B may be configured to capture images having a range between 45 degrees and 360 degrees. The captured data may be communicated to the HMD and displayed to the user on a display screen of the HMD worn by the user. In some examples, the captured data may be displayed to the user in conjunction with an artificial reality application. In some embodiments, images captured by the front-facing camera device 115A and/or the rear-facing camera device 115B may be processed before being displayed on the HMD. For example, certain features and/or objects (e.g., people, faces, devices, backgrounds, etc.) of the captured data may be subtracted, added, and/or enhanced before displaying on the HMD.

Components of the front-facing camera device 115A and the rear-facing camera device 115B may be capable of taking pictures capturing data describing the local area. A lens of the front-facing camera device 115A and/or a lens of the rear-facing camera device 115B can be automatically positioned at their target positions. A target position in a forward (or horizontal) posture of the front-facing camera device 115A may correspond to a position at which the lens of the front-facing camera device 115A is focused at a preferred focal distance (e.g., distance in the order of several decimeters). A target position in a forward (or horizontal) posture of the rear-facing camera device 115B may correspond to a position at which the lens of the rear-facing camera device 115B is focused at a hyperfocal distance in the local area (e.g., a distance of approximately 1.7 meter). An upward (vertical) posture of the front-facing camera device 115A (or the rear-facing camera device 115B) corresponds to a posture where an optical axis is substantially parallel to gravity. And a forward (horizontal) posture of the front-facing camera device 115A (or the rear-facing camera device 115B) corresponds to a posture when the optical axis is substantially orthogonal to gravity.

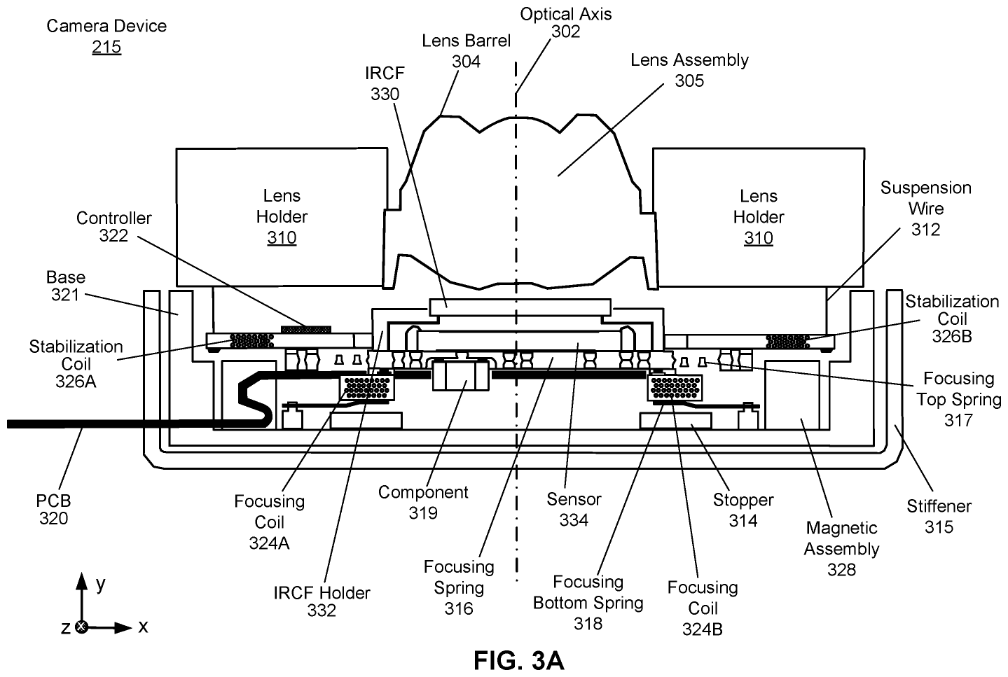

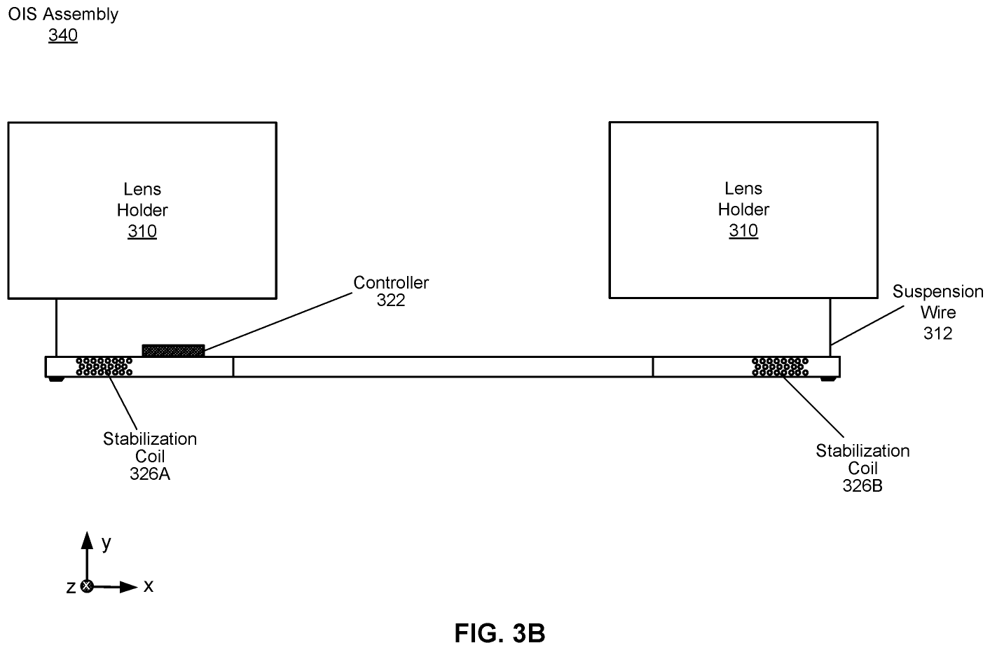

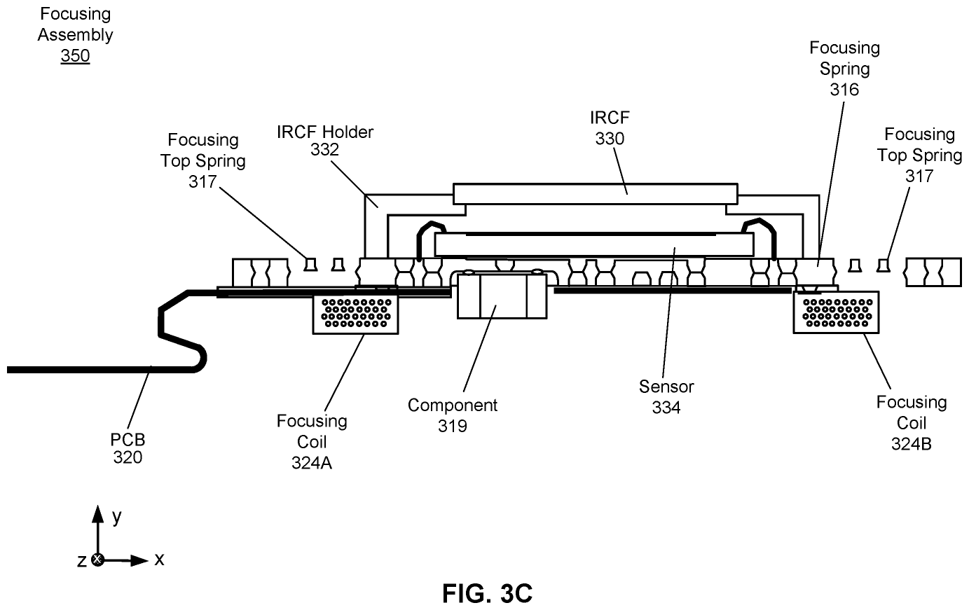

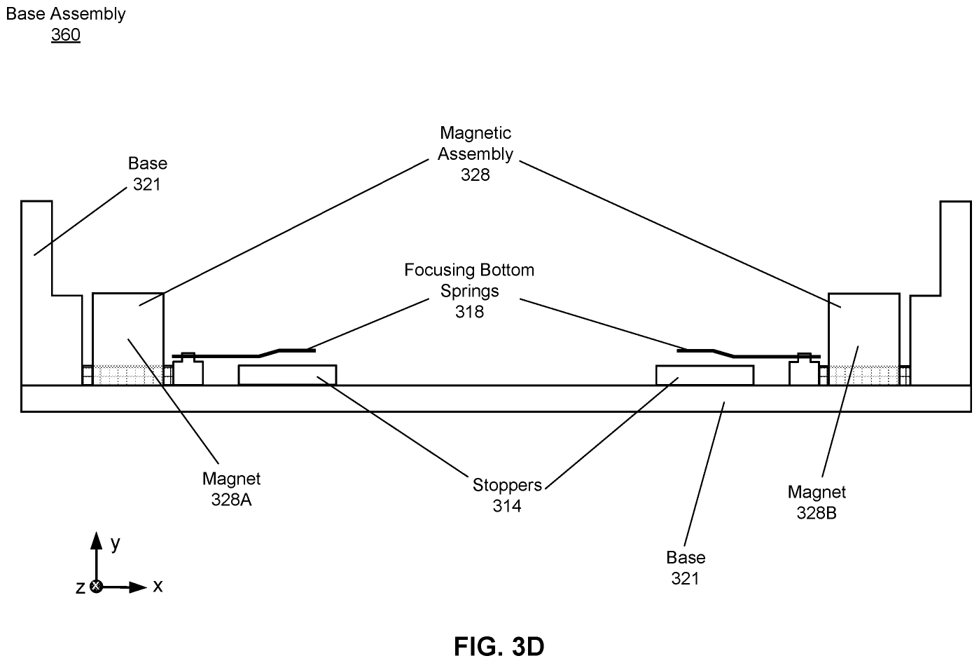

When the front-facing camera device 115A (and the rear-facing camera device 115B) changes its posture from, e.g., an upward posture to a forward posture, OIS and/or focusing may be applied by allowing a certain amount of shift (i.e., stroke) of a sensor of the front-facing camera device 115A (and the rear-facing camera device 115B) along at least one spatial direction. Details about mechanisms for achieving OIS and focusing functionalities are provided in relation to FIGS. 3A through 10.

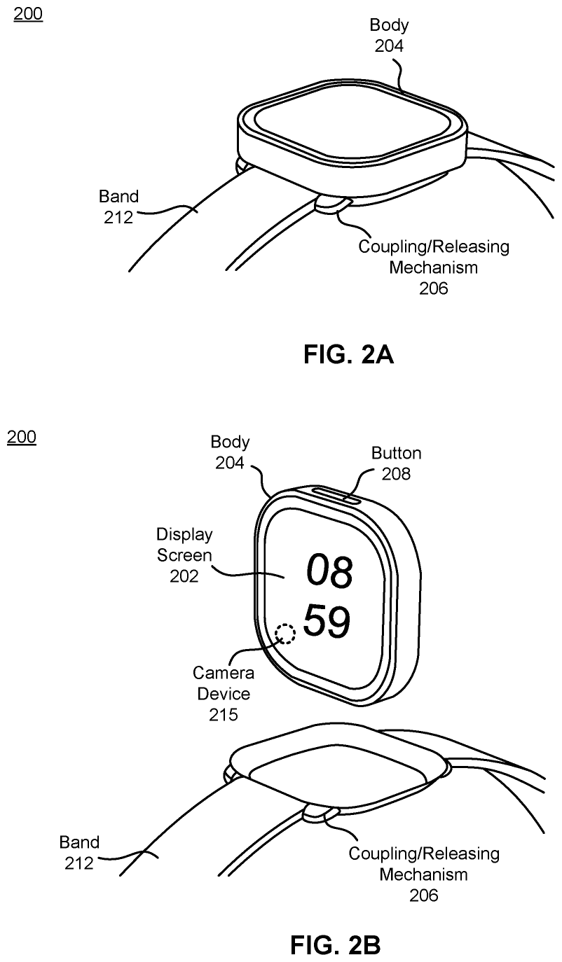

FIG. 2A is a perspective view of another example wristband system 200, in accordance with one or more embodiments. The wristband system 200 includes many of the same components described above with reference to FIGS. 1A and 1B, but a design or layout of the components may be modified to integrate with a different form factor. For example, the wristband system 200 includes a watch body 204 and a watch band 212 of different shapes and with different layouts of components compared to the watch body 104 and the watch band 112 of the wristband system 100. FIG. 2A further illustrates a coupling/releasing mechanism 206 for coupling/releasing the watch body 204 to/from the watch band 212.

FIG. 2B is a perspective view of the example wristband system 200 with the watch body 204 released from the watch band 212, in accordance with one or more embodiments. FIG. 2B further illustrates a camera device 215A, a display screen 202, and a button 208. In some embodiments, another camera device may be located on an underside of the watch body 204 and is not shown in FIG. 2B. In some embodiments (not shown in FIGS. 2A-2B), one or more sensors, a speaker, a microphone, a haptic device, a retaining mechanism, etc. may be included on the watch body 204 or the watch band 212. As the wristband system 100 and the wristband system 200 are of a small form factor to be easily and comfortably worn on a wrist of a user, the corresponding camera devices 115, 215 and various other components of the wristband system 100 and the wristband system 200 described above are designed to be of an even smaller form factor and are positioned close to each other.

When the camera device 215 changes its posture, e.g., from an upward posture to a forward posture, OIS and focusing may be applied by allowing a certain amount of shift (i.e., stroke) of a sensor of the camera device 215 along at least one spatial direction. Ranges of strokes may be asymmetric for the orthogonal spatial directions, i.e., an amount of shift along a first direction may be different than an amount of shift along a second direction orthogonal to the first direction. For example, a shifting range in a direction where more motion of the camera device 215 is expected (e.g., vertical direction) may be longer than a shifting range in the orthogonal direction (e.g., horizontal direction). Details about mechanisms for achieving OIS and focusing functionalities at the camera device 215 are provided in relation to FIGS. 3A through 10.

FIG. 3A is a cross section of the camera device 215 in an upward (vertical) posture, in accordance with one or more embodiments. The camera device 215 may capture data (e.g., one or more images) of a local area surrounding an electronic wearable device that integrates the camera device 215.

The camera device 215 includes a lens barrel 304, a lens assembly 305, lens holders 310, a stiffener 315, one or more (active or passive) components 319, a flexible printed circuit board (PCB) 320, a base 321, an infrared cut-off filter (IRCF) 330, an IRCF holder 332, and a platform that includes a plurality of suspension wires 312, one or more (soft or bottom) stoppers 314, a focusing spring 316, one or more focusing top springs 317, one or more focusing bottom springs 318, a focusing coil 324A, an optional focusing coil 324B, stabilization coils 326A, 326B, a magnetic assembly 328, and an image sensor 334. In some embodiments, the camera device 215 may also include a controller 322. In other embodiments, the controller 322 may be part of some other system (e.g., a smartwatch the camera device 215 is coupled to). In alternative configurations, different and/or additional components may be included in the camera device 215. The upward (vertical) posture of the camera device 215 corresponds to a posture of the camera device 215 where an optical axis 302 of the lens assembly 305 is substantially parallel to gravity (e.g., parallel to y axis in FIG. 3A). On the other hand, the forward (horizontal) posture of the camera device 215 corresponds to a posture of the camera device 215 where the optical axis 302 is substantially orthogonal to gravity (or parallel to x axis in FIG. 3A).

The camera device 215 may shift a location of the sensor 334 relative to the optical axis 302 to provide focusing functionality and/or OIS functionality. Thus, the camera device 215 includes both an OIS assembly and a focusing assembly. The OIS assembly of the camera device 215 may cause a translation of the sensor 334 in one or more directions perpendicular to the optical axis 302. The OIS assembly may provide an OIS functionality for the camera device 215 by stabilizing an image projected through the lens assembly 305 to the sensor 334. The OIS assembly may include the stabilization coils 326A, 326B, the suspension wires 312, and the plurality of magnets included in the magnetic assembly 328. The OIS assembly may include more or fewer components. More details about a structure of the OIS assembly are provided in relation to FIG. 3B.

The focusing assembly of the camera device 215 may cause a translation of the sensor 334 in a direction parallel to the optical axis 302 (e.g., along y direction). The focusing assembly may provide an auto focus functionality for the camera device 215. The focusing assembly may include the focusing spring 316, the focusing coils 324A, 324B, and the plurality of magnets included in the magnetic assembly 328. The focusing assembly may include more or fewer components. More details about a structure of the focusing assembly are provided in relation to FIG. 3C.

The lens barrel 304 is a mechanical structure or housing for carrying one or more lenses of the lens assembly 305. The lens barrel 304 is a hollow structure with an opening on opposite ends of the lens barrel 304. The openings may provide a path for light (e.g., visible light, infrared light, etc.) to transmit between a local area and the sensor 334. Inside the lens barrel 304, one or more lenses of the lens assembly 305 are positioned between the two openings.

The lens assembly 305 is a stationary structure that focuses light from a local area to a target area of the platform. The lens assembly 305 is coupled to one or more lens holders 310 that hold one or more lenses of the lens assembly 305 in optical series. The target area may include the sensor 334 on the platform for capturing the light from the local area. The lens holders 310 may be stationary relative to the platform, such that the one or more lenses of the lens assembly 305 are fixed in place along the optical axis 302. The one or more lenses in the lens assembly 305 may have a fixed (i.e., frozen) vertical position (e.g., along y direction).

The platform including the focusing coils 324A, 324B, the stabilization coils 326A, 326B, and the sensor 334 may move to provide focusing functionality and/or OIS functionality. The platform may be suspended from the lens assembly 305, e.g., by the suspension wires 312. The suspension may be such that the platform moves horizontally (e.g., along x direction) relative to the lens assembly 305. A sag can occur only in the vertical direction (e.g., along y direction) as the sensor 334 moves down due to gravity. The sag can be compensated by including an additional lens in the lens assembly 305 that moves along the vertical direction. The platform may be in a fixed position achieved by supplying constant current through the stabilization coils 326A, 326B.

The sensor 334 may detect light received by the camera device 215 from the local area that passes through the one or more lenses of the lens assembly 305. The sensor 334 may also be referred to as an “image sensor.” The sensor 334 may be, e.g., a complementary metal oxide semiconductor (CMOS) sensor, a charge coupled device (CCD) sensor, some other device for detecting light, or some combination thereof. Data (e.g., images) captured by the sensor 334 may be provided to the controller 322 or to some other controller (e.g., image signal processor, not shown in FIG. 3A). The sensor 334 may include one or more individual sensors, e.g., a photodetector, a CMOS sensor, a CCD sensor, a pixel, some other device for detecting light, or some combination thereof. The individual sensors may be in an array. The sensor 334 may capture visible light and/or infrared light from the local area. The visible and/or infrared light may be focused from the local area to the sensor 334 via the lens barrel 304. The sensor 334 may include various filters, such as the IRCF 330, one or more other color filters, a micro lens on each pixel of the sensor 334, some other device for filtering light, or some combination thereof. The IRCF 330 is a filter configured to block the infrared light and the ultraviolet light from the local area and propagate the visible light to the sensor 334. The IRCF 330 may be placed within the IRCF holder 332. The IRCF 330 together with the IRCF holder 332 may form an IRCF assembly.

The sensor 334 may be coupled and/or integrated into the platform. In some embodiments, the PCB may be also part of the platform. The sensor 334 may be coupled to the platform such that the platform is configured to move the sensor 334 in one or more directions relative to the optical axis 302. In some embodiments, the one or more components 319 (e.g., passive components, active components, etc.) may be recessed into a substrate (or placed on a same surface as the sensor 334) on the platform. The one or more recessed components 319 may facilitate a reduction in form factor Z (parallel to the optical axis 302) of the camera device 215.

Each focusing coil 324A, 324B may be configured to conduct electricity by being supplied with a respective current. Current may be provided to the focusing coil 324A, 324B to adjust a position (e.g., in a direction parallel to the optical axis 302) of the platform as part of a focusing operation (i.e., auto focus). In some embodiments, same currents (e.g., currents of same amplitudes and polarities) are supplied to the focusing coils 324A, 324B. In some other embodiments, different currents (e.g., currents of different amplitudes and/or different polarities) are supplied to the focusing coils 324A, 324B. The focusing coils 324A, 324B may be positioned symmetrically about the optical axis 302. For example, each individual focusing coil 324A, 324B may be positioned symmetrically about the optical axis 302, as illustrated in FIG. 3A. Each focusing coil 324A, 324B may be aligned to one side of a respective magnet of the magnetic assembly 328.

Each stabilization coil 326A, 326B may be configured to conduct electricity by being supplied with a respective current. Current may be provided to at least one of the stabilization coils 326A, 326B to adjust a position (e.g., in one or more directions perpendicular to the optical axis 302) of the platform as part of an OIS operation. In some embodiments, same currents (e.g., currents of same amplitudes and polarities) are supplied to the stabilization coils 326A, 326B. In some other embodiments, different currents (e.g., currents of different amplitudes and/or different polarities) are supplied to the stabilization coils 326A, 326B. The stabilization coils 326A, 326B may be positioned symmetrically about the optical axis 302. For example, each individual stabilization coil 326A, 326B may be positioned symmetrically about the optical axis 302, as illustrated in FIG. 3A. Each stabilization coil 326A, 326B may be aligned to one side of a respective magnet of the magnetic assembly 328.

The magnetic assembly 328 may provide a magnetic field that can be used for translating the platform with the sensor 334 parallel to the optical axis 302 (e.g., for focusing) and/or perpendicular to the optical axis 302 (e.g., for OIS). The magnetic assembly 328 may include a plurality of magnets that produce a magnetic field, and may be fixed in place relative to the lens assembly 305. The magnetic assembly 328 may be coupled to a static portion of the camera device 215 such that the magnetic assembly 328 is fixed in place and is stationary relative to the lens assembly 305. Current supplied to at least one of the stabilization coils 326A, 326B may interact with the magnetic field to cause the sensor 334 to translate in one or more directions perpendicular to the optical axis 302 (e.g., along x direction and/or z direction), thus providing the OIS functionality to the camera device 215. By applying different levels of current on different stabilization coils 326A, 326B, the sensor 334 may be translated diagonally relative the optical axis, i.e., the sensor may be translated along a first direction (e.g., x direction) orthogonal to the optical axis 302 and also along a second direction (e.g., z direction) orthogonal to the optical axis 302. Current supplied to at least one of the stabilization coils 326A, 326B may be applied in the forward (horizontal) posture of the camera device 215, e.g., to stabilize an image taken by the sensor 334.

Similarly, current supplied to the focusing coils 324A, 324B may interact with the magnetic field to cause the sensor 334 to translate towards or away from the one or more lenses of the lens assembly 305 (i.e., along y direction parallel to the optical axis 302) and thus providing focusing functionality to the camera device 215. By applying currents of a same level on both focusing coils 324A, 324B, tilting of the sensor 334 relative to the optical axis 302 may be achieved. Current supplied to the focusing coils 324A, 324B may be applied in the forward (horizontal) posture of the camera device 215, e.g., to focus the sensor 334 and the lens assembly 305 at the hyperfocal distance.

The magnetic assembly 328 may include a magnet holder (not shown in FIG. 3A) for holding the plurality of magnets. The magnet holder may provide a rigid structure to support the plurality of magnets. In some embodiments, the magnet holder may enclose all sides of the magnets. In other embodiments, the magnet holder may enclose all sides of the magnets except for a side facing the focusing coils 324A, 324B. In some embodiments, one or more exterior surfaces of the magnetic assembly 328 are coated with a polymer (e.g., a sub-micron thick polymer).

Each magnet in the magnetic assembly 328 may be of a different size or of the same size. In some embodiments, each magnet in the magnetic assembly 328 is curved about the optical axis 302 conforming to the curvature of the focusing coils 324A, 324B and/or the curvature of the stabilization coils 326A, 326B. In some embodiments, each magnet in the magnetic assembly 328 is straight. For example, at least two opposing sides of each magnet in the magnetic assembly 328 may be parallel to a plane that is parallel to the optical axis 302. Each magnet in the magnetic assembly 328 may include rectangular cross sections with one axis of a cross section being parallel to the optical axis 302 and another axis of the cross section being perpendicular to the optical axis 302. In some embodiments, each magnet in the magnetic assembly 328 may include other types of cross-sectional shapes such as square or any other shape that includes at least one straight-edged side that faces the focusing coils 324A, 324B. Each magnet in the magnetic assembly 328 may be a permanent magnet that is radially magnetized with respect to the optical axis 302. The magnets of the magnetic assembly 328 may be positioned symmetrically or asymmetrically about the optical axis 302.

An outer shell (not shown in FIG. 3A) encloses the components of the camera device 215, while including an aperture through which light may reach the one or more lenses of the lens assembly 305. In some embodiments, the outer shell may be rectangular-shaped. In alternative embodiments, the outer shell may be circular, square, hexagonal, or any other shape. In some embodiments, portions of the lens assembly 305 may be the outer shell. For example, the lens holder 310 may be part of the outer shell. In some embodiments, the stiffener 315 may be a bottom portion of the outer shell. The outer shell may be manufactured from a wide variety of materials ranging from plastic to metals. In some examples, the outer shell is manufactured from a same material as the material of an electronic wearable device the outer shell is coupled to such that the outer shell is not distinguishable from the rest of the electronic wearable device. In some embodiments, the outer shell is manufactured from a material that provides a magnetic shield to surrounding components of the electronic wearable device. In these embodiments, the outer shell is a shield can. In some embodiments, one or more interior surfaces of the outer shell are coated with a polymer. In embodiments where the camera device 215 is part of an electronic wearable device (e.g., a smartwatch), the outer shell may couple to (e.g., be mounted on, affixed to, attached to, etc.) another component of the electronic wearable device, such as a frame of the electronic wearable device. For example, the outer shell may be mounted on a watch body (e.g., the watch body 104) of the smartwatch.

The PCB 320 is a moving component of the platform of the camera device 215. The PCB 320 may be positioned below the sensor 334 along the optical axis 302. The PCB 320 may be implemented as a flexible PCB that can be bent, e.g., to clear any mechanical movement effects. The PCB 320 may provide electrical connections for one or more components of the camera device 215. The PCB 320 may electrically connect the controller 322 to different components of the camera device 215, such as the sensor 334, the focusing coils 324A, 324B, the stabilization coils 326A, 326B, etc. In some embodiments, the controller 322 is located on the PCB 320.

The controller 322 may control the components of the camera device 215. In some embodiments, the controller 322 processes image data captured by the sensor 334. In some other embodiments, instead of the controller 322, a different controller not shown in FIG. 3A (e.g., image signal processor) is configured to process image data captured by the sensor 334. The controller 322 may control OIS and/or focusing operations at the camera device 215. The controller 322 may control an amount and/or a polarity (e.g., a direction) of a respective current applied to each stabilization coil 326A, 326B in order to translate the platform with the sensor 334 in one or more directions perpendicular to the optical axis 302 to offset motion of the camera device 215 (i.e., perform image stabilization). Additionally or alternatively, the controller 322 may control an amount and/or a polarity (e.g., a direction) of a respective current applied to each focusing coil 324A, 324B in order to translate the platform with the sensor 334 in a direction parallel to the optical axis 302 (i.e., move the sensor 334 towards or away from the lens assembly 305) for achieving desired focusing of the camera device 215.

Due to the Lorentz force principle, when current flows through at least one of the stabilization coils 326A-326B and passes the magnetic fields generated by the magnetic assembly 328, an orthogonal Lorentz force is created. The Lorentz force drives at least one of the stabilization coils 326A, 326B to move orthogonally relative to one or more magnets of the magnetic assembly 328. For example, by driving a particular amount of current through each stabilization coil 326A, 326B, a force is produced that causes the stabilization coils 326A, 326B to move relative to the plurality of magnets of the magnetic assembly 328, thereby causing the platform coupled to the stabilization coils 326A, 326B to translate in a direction perpendicular to the optical axis 302. In a similar manner, by driving a particular amount of current through each focusing coil 324A, 324B, a force is produced that causes the focusing coils 324A, 324B to move relative to the plurality of magnets of the magnetic assembly 328, thereby causing the platform with the sensor 334 coupled to the focusing coils 324A, 324B to translate in a direction parallel to the optical axis 302.

In some embodiments, the focusing spring 316, the one or more focusing top springs 317, and the one or more focusing bottom springs 318 may be configured to position the platform with the sensor 334 to a neutral position when current is not applied to the focusing coils 324A, 324B and/or the stabilization coils 326A, 326B. The neutral position is a position of the sensor 334 within the platform when the camera device 215 is not undergoing focusing (e.g., via the focusing coils 324A, 324B) nor stabilizing (e.g., via the stabilization coils 326A, 326B). The focusing spring 316, the one or more focusing top springs 317, and the one or more focusing bottom springs 318 may be shape-memory alloy (SMA) wires. In some embodiments, the one or more bottom springs 318 are conductors and may be coupled to the focusing coils 324A, 324B. The focusing spring 316 may ensure the lens barrel 304 does not fall out or come into contact with the sensor 334. In some embodiments, the suspension wires 312 that suspend the platform from the lens assembly 305 and the lens holders 310 may include some or all of the functionality of the focusing spring 316, the one or more focusing top springs 317, and the one or more focusing bottom springs 318. The suspension wires 312 may be positioned symmetrically about the optical axis 302.

Note that conventional lens-shift cameras with a voice coil motor (VCM) would have to move a much larger weight than the camera device 215 presented herein. In contrast, the sensor-shift OIS/focusing presented herein moves a relatively light weight (from the sensor 334, the substrate, the focusing coils 324A, 324B, and the stabilization coils 326A, 326B), so the sensor-shift OIS/focusing can reduce power consumption and mechanical design weakness. Moreover, conventional camera systems with a moving auto focusing lens cannot seal fully to prevent particle ingress into a camera device because there is a space between a lens carrier and a shield can. In contrast, the camera device 215 presented herein is fully sealed, and can perform auto focus by shifting the sensor 334 in a direction parallel to the optical axis 302.

FIG. 3B is a cross section of an OIS assembly 340 of the camera device 215, in accordance with one or more embodiments. The OIS assembly 340 may include: the lens holder 310, the suspension wires 312, the stabilization coils 326A, 326B, the controller 322, and one or more passive components (not shown in FIG. 3B) placed on at least one of the stabilization coils 326A, 326B. The OIS assembly 340 may include more or fewer components than what is shown in FIG. 3B. Turnings of the stabilization coils 326A, 326B may be aligned to the plurality of magnets of the magnetic assembly 328 and an apertured center of the lens barrel 304 to prevent any image blocking by the stabilization coils 326A, 326B. Each stabilization coil 326A, 326B may be suspended from a corresponding lens holder 310 by a corresponding suspension wire 312. When different current is applied to each stabilization coil 326A, 326B, the platform of the camera device 215 including the sensor 334, the IRCF 330 and the IRCF holder 332 may move to an anti-sharing direction either horizontally (e.g., along x direction) or diagonally (e.g., along x and z directions). Sensitivity of the stabilization coils 326A, 326B and a maximum stroke of the platform with the sensor 334 may be limited by design of the suspension wires 312 (e.g., by a diameter and length of the suspension wires 312), as well as by a material and number of coil turnings in the stabilization coils 326A, 326B.

FIG. 3C is a cross section of a focusing assembly 350 of the camera device 215, in accordance with one or more embodiments. The focusing assembly 350 may include: the focusing spring 316, the one or more focusing top strings 317, the sensor 334, the IRCF 330, the IRCF holder 332, the focusing coils 324A, 324B, the one or more (passive or active) components 319, and the PCB 320. The focusing assembly 350 may include more or fewer components than what is shown in FIG. 3C. Electrical signals (including power supply signals) may be traced on a top area (e.g., with a wire bonding pad) and a bottom area (e.g., with an anisotropic conductive film (ACF) pad) of a center of each structure of respective focusing coil 324A, 324B. In one or more embodiments, at least one passive component (not shown in FIG. 3C) can be placed on a front area of the platform (e.g., on the same front area as the sensor 334) and/or a bottom area of each structure of respective focusing coil 324A, 324B. The focusing spring 316 may be patterned by etching between a mount of the sensor 334 and a joint area of the OIS assembly 340, e.g., to form the one or more focusing top springs 317. The one or more focusing top springs 317 may be made of copper alloy, or some other suitable material. Each focusing coil 324A, 324B may be located such that to be aligned to, e.g., four corners of the plurality of magnets of the magnetic assembly 328. The PCB 320 may connect bottom areas of structures of the focusing coils 324A, 324B, e.g., via ACF or some other process. The sensor 334 may move vertically (e.g., along y direction) after current is applied to at least one of the focusing coils 324A, 324B and due to an interaction of the current with the magnetic field generated by the magnetic assembly 328. A focusing stroke of the platform with the sensor 334 may be defined by, e.g., a number of turns in each focusing coil 324A, 324B, and/or a stiffness of the focusing spring 316.

FIG. 3D is a cross section of a base assembly 360 of the camera device 215, in accordance with one or more embodiments. The base assembly 360 may include: the base 321 with four corner (or four side) magnets 328A, 328B of the magnetic assembly 328, the (soft or bottom) stopper 314, and the focusing bottom springs 318. The base assembly 360 may include more or fewer components than what is shown in FIG. 3D. The OIS assembly 340 and the focusing assembly 350 may be placed on a top side of the base 321. The magnets 328A, 328B may be placed at corners (or center of each side) of the base 321 and into magnet gel pockets. After that, a glue may be dispensed to freeze (i.e., fix) positions of the magnets 328A, 328B. A maximum focusing stroke of the platform with the sensor 334 may be further limited by a stiffness of the bottom springs 318. The stoppers 314 placed on a surface of the base 321 may minimize mechanical shock during an unexpected external stress.

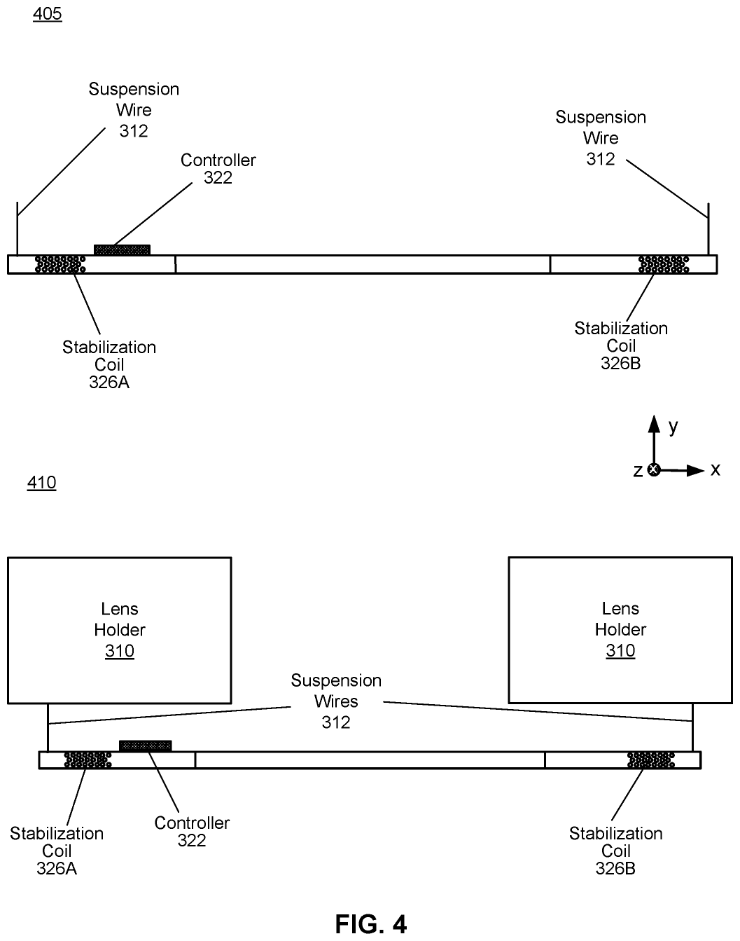

FIG. 4 illustrates an example process of assembling the OIS assembly 340 of FIG. 3B, in accordance with one or more embodiments. At 405, surface mounting of OIS and focusing components on top of each structure of a respective stabilization coil 326A, 326B may be performed, followed by soldering of the suspension wires 312. At 410, the suspension wires 312 may be aligned and glued to the lens holders 310.

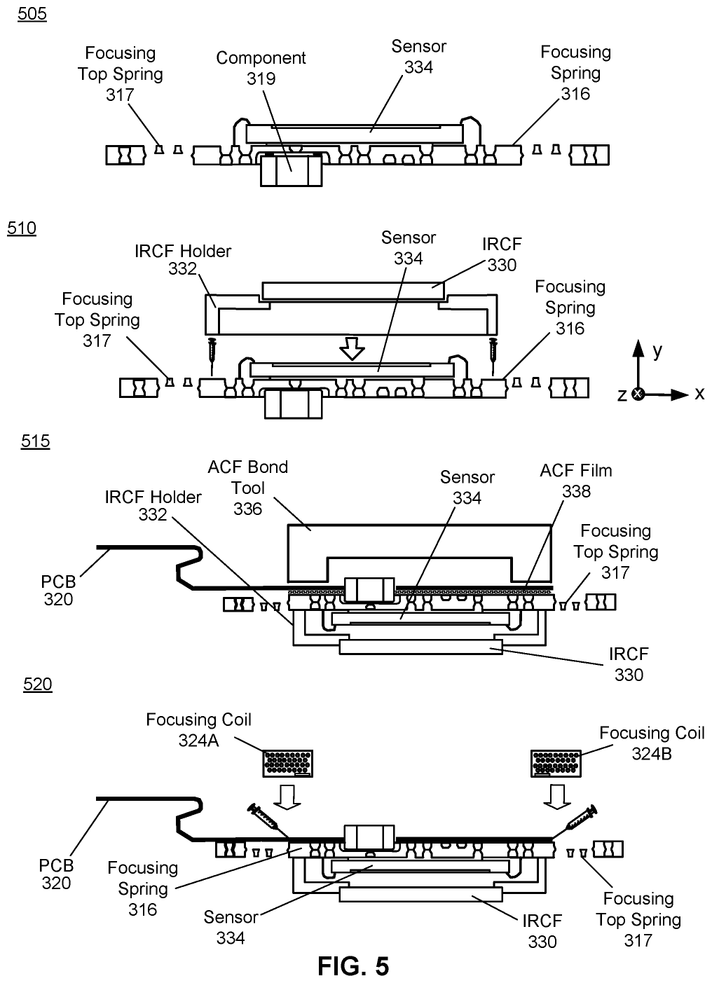

FIG. 5 illustrates an example process of assembling the focusing assembly 350 of FIG. 3C, in accordance with one or more embodiments. At 505, one or more (passive or active) components 319 may be mounted on a back area of the focusing spring 316 and/or on a top area of the focusing spring 316 (e.g., the same area where the sensor 334 is mounted on); the sensor 334 may be bonded on a top area of the focusing spring 316, and wire bonding may be performed to connect the sensor 334 and signal traces on the focusing coils 324A, 324B. At 510, an IRCF assembly including the IRCF 330 and the IRCF holder 332 may be mounted on the top area of the focusing spring 316 after aligning to the sensor 334. An epoxy may be dispensed on the top area of the focusing spring 316 and the focusing top springs 317 to attach the IRCF assembly. At 515, the PCB 320 may be bonded to the top area of the focusing spring 316 by the ACF process (or some other similar process) after flipping the focusing spring 316. An ACF bonding may be performed (e.g., by an ACF bond tool 336) to attach the PCB 320 (e.g., via an ACF film 338) on a bottom area of the focusing spring 316 and the focusing top springs 317. At 520, an epoxy may be dispensed on the bottom area of the focusing spring 316 and the focusing top springs 317 to attach the focusing coils 324A, 324B; and each of the focusing coils 324A, 324B may be aligned to the focusing spring 316. Soldering and glue paste may be applied at the focusing spring 316 and/or the PCB 320 for better adhesion of the focusing coils 324A, 324B.

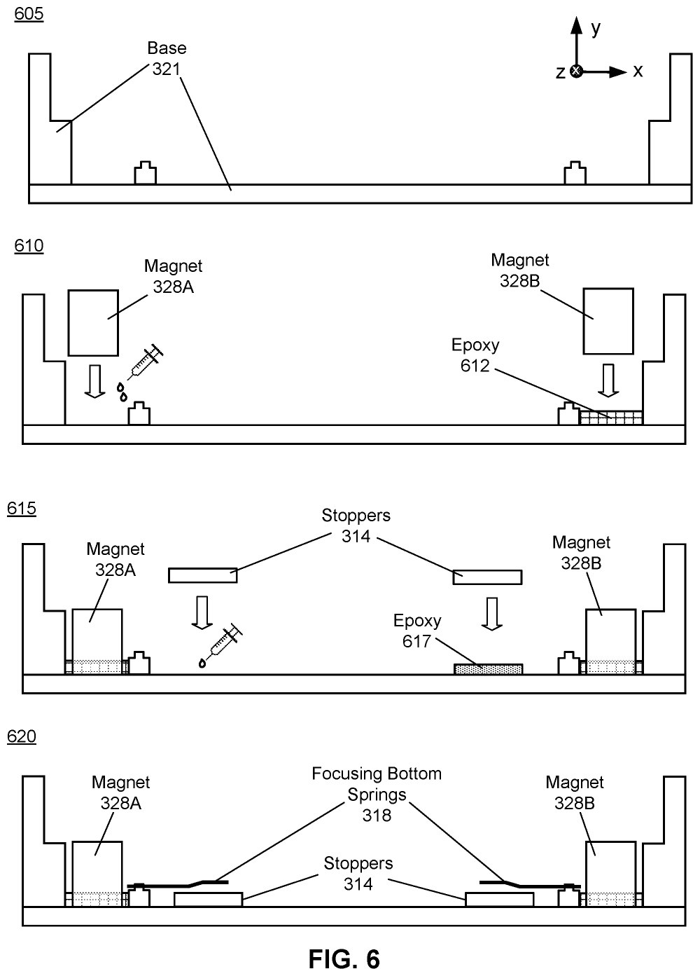

FIG. 6 illustrates an example process of assembling the base assembly 360 of FIG. 3D, in accordance with one or more embodiments. The base 321 is a plastic mold component of the base assembly 360. At 605, the base 321 (and optionally one or more other components of the base assembly 360) may go through a quality control process. At 610, an epoxy 612 (and/or a glue) may be dispensed into magnet holder pockets, and the magnets 328A, 328B may be aligned to the magnet holder pockets. At 615, an epoxy 617 (and/or a glue) may be dispensed inside the base 321, and the stoppers 314 may be attached to the base 321. At 620, the bottom springs 318 may be aligned to the base 321 and dispensed in order to freeze their positions.

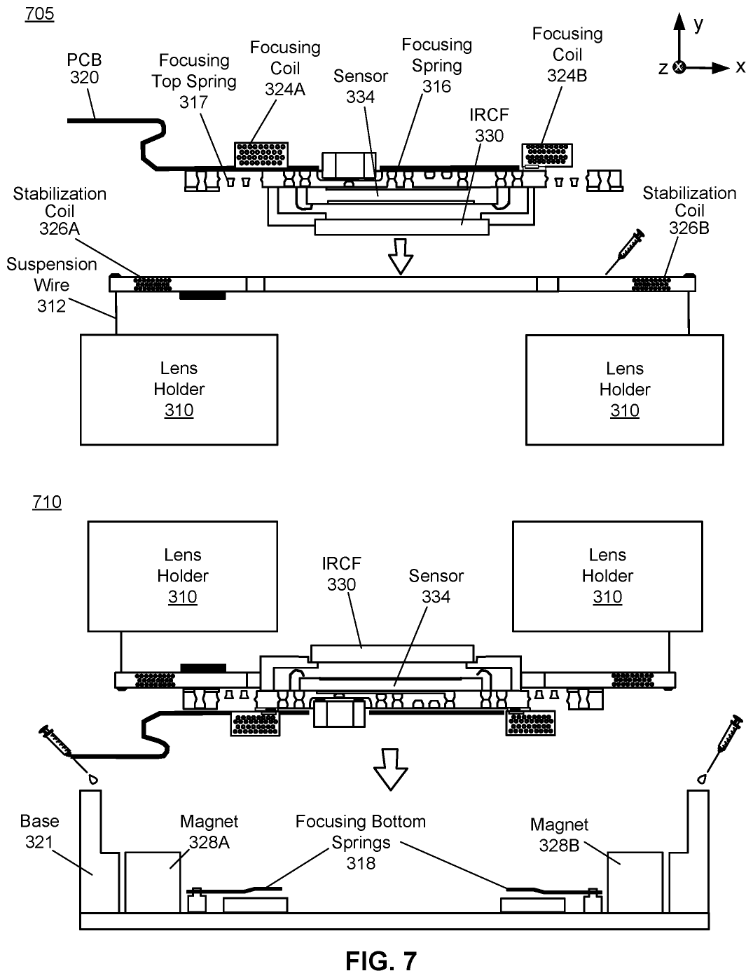

FIG. 7 illustrates an example process of assembling a platform of the camera device 215, in accordance with one or more embodiments. As aforementioned, the platform may include components for performing both OIS and focusing functionalities of the camera device 215. The platform as assembled in FIG. 7 may include: the suspension wires 312, the focusing spring 316, the focusing top springs 317, the PCB 320, the focusing coils 324A, 324B, the stabilization coils 326A, 326B, the IRCF assembly, and the sensor 334. The platform may include more or fewer components than what is shown in FIG. 7. At 705, a surface mounting process for OIS/focusing components on top of each structure of a respective stabilization coil 326A, 326B may be performed, which may be followed by soldering of the suspension wires 312. At 710, the suspension wires 312 may be aligned to the lens holders 310; and the components of the platform may be glued to the base 321.

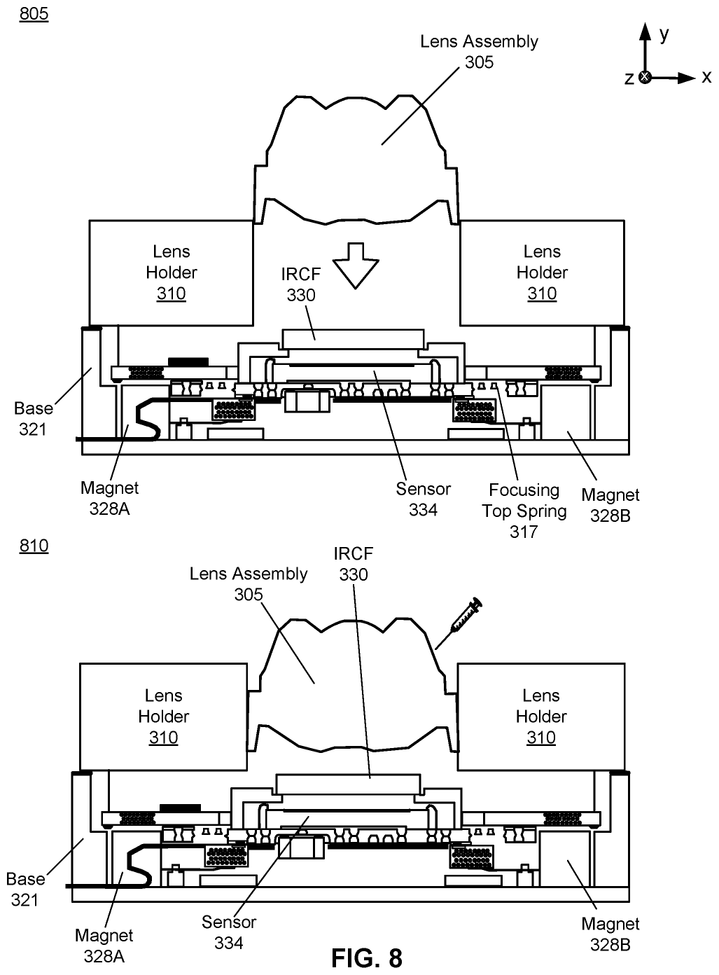

FIG. 8 illustrates an example process of assembling the lens assembly 305 to a platform of the camera device 215, in accordance with one or more embodiments. The platform may be assembled according to the process illustrated in FIG. 7. At 805, the base 321 (and optionally one or more other components of the base assembly 360 of FIG. 3D) may go through a quality control process. At 810, a glue may be dispensed into magnet holder pockets, and the magnet 328A, 328B may be aligned to the magnet holder pockets.

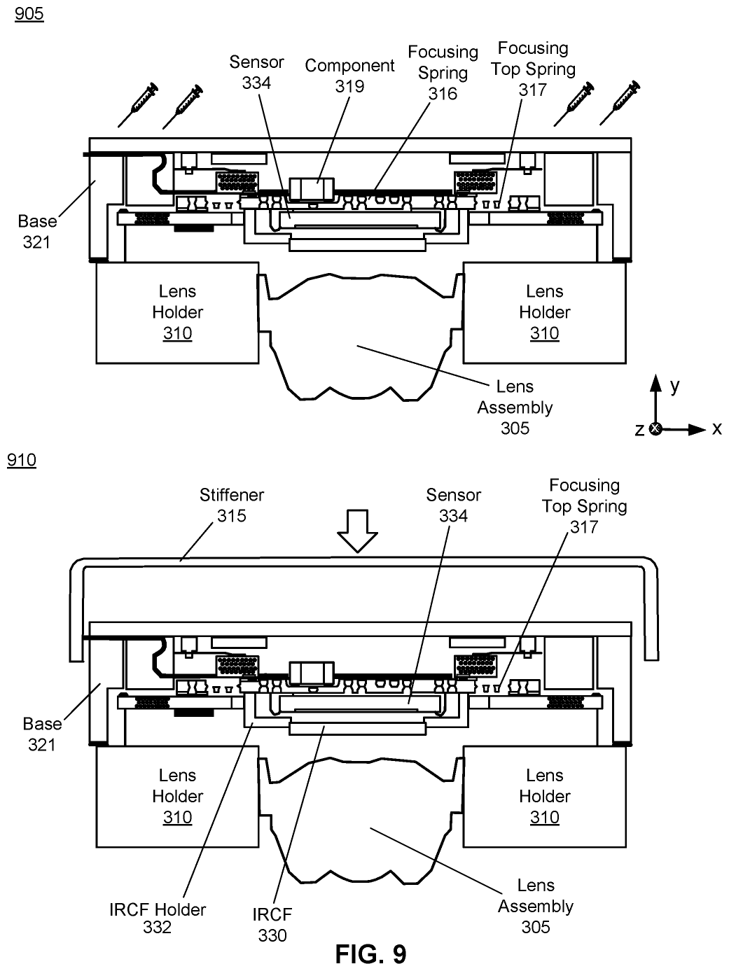

FIG. 9 illustrates an example process of attaching the stiffener 315 to the base 321 (and to other components of the base assembly 360 of FIG. 3D), in accordance with one or more embodiments. At 905, the one or more (passive or active) components 319 may be mounted on the back of the focusing spring 316; the sensor 334 may be bonded on the top area of the focusing spring 316 and the focusing top springs 317; wire bonding may be performed to connect the sensor 334 and signal traces on the focusing coils 324A, 324B; and one or more glues (e.g., a non-conductive glue and/or a conductive glue) may be applied to the base 321. At 910, the stiffener 315 may be attached to the base 321, e.g., via the non-conductive glue and/or the conductive glue; the IRCF assembly including the IRCF 330 and the IRCF holder 332 may be aligned to the sensor 334; and the IRCF assembly may be mounted on the top area of the focusing spring 316 and the focusing top springs 317.

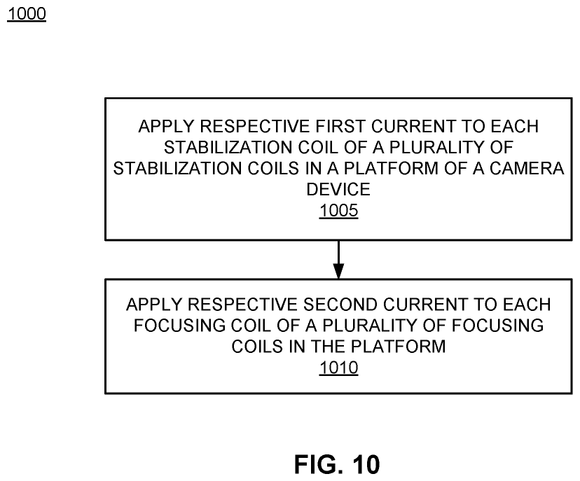

FIG. 10 is a flowchart illustrating a process 1000 of initiating movement of a sensor at a camera device for OIS and focusing, in accordance with one or more embodiments. Steps of the process 1000 may be performed by one or more components of the camera device (e.g., the camera device 215). The camera device may be part of a smartwatch or some other wearable electronic device. Embodiments may include different and/or additional steps of the process 1000, or perform the steps of the process 1000 in different orders.

The camera device applies 1005 respective first current to each stabilization coil of a plurality of stabilization coils in a platform of the camera device. Each stabilization coil of the plurality of stabilization coils may be aligned to a first side of a respective magnet of a plurality of magnets in a magnetic assembly of the camera device. The respective first current may interact with a magnetic field produced by the magnetic assembly to cause the sensor in the platform to translate in at least one direction relative to an optical axis of a lens assembly of the camera device that is fixed in place to a lens holder of the camera device. The platform may be suspended from the lens holder and configured to move the sensor in one or more directions relative to the optical axis. The magnetic assembly may be fixed in place relative to the lens holder.

The sensor of the camera device may be in a neutral position when no current is applied to each stabilization coil of the plurality of stabilization coils. In one embodiment, the sensor moves from the neutral position to another position in the direction orthogonal to the optical axis when the respective first current is applied to each stabilization coil of the plurality of stabilization coils. In another embodiment, the sensor moves from the neutral position to another position in the direction orthogonal to the optical axis and in another direction orthogonal to the optical axis when the respective first current is applied to each stabilization coil of the plurality of stabilization coils. Each stabilization coil of the plurality of stabilization coils may be suspended from the lens holder by a corresponding suspension wire.

The camera device applies 1010 respective second current to each focusing coil of a plurality of focusing coils in the platform. Each focusing coil of the plurality of focusing coils may be aligned to a second side of the respective magnet, and the respective second current may interact with the magnetic field to cause the sensor to translate towards or away from the lens assembly.

The sensor may be in a neutral position when no current is applied to each focusing coil of the plurality of focusing coils, and the sensor may move from the neutral position to another position in a direction parallel to the optical axis when the respective second current is applied to each focusing coil of the plurality of focusing coils. The camera device may further include a plurality of suspension wires configured to suspend the platform from the lens holder. One or more (passive or active) components may be recessed into a substrate on the platform. Alternatively, the one or more (passive or active) components may be placed on a top area of the substrate. The platform may further include a flexible PCB connecting the plurality of focusing coils with each other. The camera device may further include one or more springs configured to position the platform to a neutral position when current is not applied to at least one of the stabilization coils and the focusing coils.

The camera device may rotate around the optical axis when changing orientation from a first orientation to a second orientation during which the sensor translates towards or away from the lens assembly and in the direction orthogonal to the optical axis caused by the respective first current and the respective second current interacting with the magnetic field. The optical axis may be parallel to gravity when the camera device is at the first orientation, and the optical axis may be orthogonal to gravity when the camera device is at the second orientation.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A camera device comprising:
a lens assembly fixed in place to a lens holder, the lens assembly positioned along an optical axis;
a magnetic assembly including a plurality of magnets that produce a magnetic field; and
a platform that includes a plurality of stabilization coils, a plurality of focusing coils, and a sensor that is configured to detect light from the lens assembly, the platform configured to move the sensor in one or more directions relative to the optical axis, each stabilization coil of the plurality of stabilization coils aligned to a first side of a respective magnet of the plurality of magnets and supplied with respective first current that interacts with the magnetic field causing the sensor to translate in a direction orthogonal to the optical axis, and each focusing coil of the plurality of focusing coils aligned to a second side of the respective magnet and supplied with respective second current that interacts with the magnetic field causing the sensor to translate towards or away from the lens assembly.

2. The camera device of claim 1, wherein the sensor is in a neutral position when no current is applied to each stabilization coil of the plurality of stabilization coils, and the sensor moves from the neutral position to another position in the direction orthogonal to the optical axis when the respective first current is applied to each stabilization coil of the plurality of stabilization coils.

3. The camera device of claim 1, wherein the sensor is in a neutral position when no current is applied to each stabilization coil of the plurality of stabilization coils, and the sensor moves from the neutral position to another position in the direction orthogonal to the optical axis and in another direction orthogonal to the optical axis when the respective first current is applied to each stabilization coil of the plurality of stabilization coils.

4. The camera device of claim 1, wherein the sensor is in a neutral position when no current is applied to each focusing coil of the plurality of focusing coils, and the sensor moves from the neutral position to another position in a direction parallel to the optical axis when the respective second current is applied to each focusing coil of the plurality of focusing coils.

5. The camera device of claim 1, wherein the magnetic assembly is fixed in place relative to the lens holder.

6. The camera device of claim 1, wherein each stabilization coil of the plurality of stabilization coils is suspended from the lens holder by a corresponding suspension wire.

7. The camera device of claim 1, wherein the platform is suspended from the lens holder.

8. The camera device of claim 7, further comprising a plurality of suspension wires configured to suspend the platform from the lens holder.

9. The camera device of claim 1, wherein one or more components are recessed into a substrate on the platform.

10. The camera device of claim 1, wherein the platform further includes a flexible printed circuit board connecting the plurality of focusing coils with each other.

11. The camera device of claim 1, further comprising one or more springs configured to position the platform to a neutral position when current is not applied to at least one of the stabilization coils and the focusing coils.

12. The camera device of claim 1, wherein the camera device rotates around the optical axis when changing orientation from a first orientation to a second orientation during which the sensor translates towards or away from the lens assembly and in the direction orthogonal to the optical axis caused by the respective first current and the respective second current interacting with the magnetic field.

13. The camera device of claim 12, wherein the optical axis is parallel to gravity when the camera device is at the first orientation, and the optical axis is orthogonal to gravity when the camera device is at the second orientation.

14. The camera device of claim 1, wherein the camera device is part of a wearable electronic device.

15. A camera device comprising:
a lens assembly fixed in place to a lens holder, the lens assembly positioned along an optical axis;
a magnetic assembly including a plurality of magnets that produce a magnetic field; and
a platform that includes a plurality of stabilization coils and a sensor that is configured to detect light from the lens assembly, the platform configured to move the sensor in one or more directions relative to the optical axis, each stabilization coil of the plurality of stabilization coils aligned to a first side of a respective magnet of a plurality of magnets and supplied with respective first current that interacts with the magnetic field causing the sensor to translate in at least one direction relative to the optical axis.

16. The camera device of claim 15, wherein the sensor is in a neutral position when no current is applied to each stabilization coil of the plurality of stabilization coils, and the sensor moves from the neutral position to another position in at least one of a first direction orthogonal to the optical axis and a second direction orthogonal to the optical axis when the respective first current is applied to each stabilization coil of the plurality of stabilization coils.

17. The camera device of claim 15, wherein the platform further includes a plurality of focusing coils, each focusing coil of the plurality of focusing coils aligned to a second side of the respective magnet and supplied with second current that interacts with the magnetic field causing the sensor to translate towards or away from the lens assembly.

18. The camera device of claim 15, wherein:
the magnetic assembly is fixed in place relative to the lens holder;
each stabilization coil of the plurality of stabilization coils is suspended from the lens holder by a corresponding suspension wire; and
the platform is suspended from the lens holder a plurality of suspension wires.

19. A method comprising:
applying respective first current to each stabilization coil of a plurality of stabilization coils in a platform of a camera device, each stabilization coil of the plurality of stabilization coils aligned to a first side of a respective magnet of a plurality of magnets in a magnetic assembly of the camera device, the respective first current interacting with a magnetic field produced by the magnetic assembly to cause a sensor in the platform to translate in at least one direction relative to an optical axis of a lens assembly of the camera device that is fixed in place to a lens holder of the camera device, the platform suspended from the lens holder and configured to move the sensor in one or more directions relative to the optical axis; and
applying respective second current to each focusing coil of a plurality of focusing coils in the platform, each focusing coil of the plurality of focusing coils aligned to a second side of the respective magnet, the respective second current interacting with the magnetic field to cause the sensor to translate towards or away from the lens assembly.

20. The method of claim 19, further comprising:
applying the respective first current to each stabilization coil of the plurality of stabilization coils to move the sensor from a neutral position to a first position in at least one of a first direction orthogonal to the optical axis and a second direction orthogonal to the optical axis; and
applying the respective second current to each focusing coil of the plurality of focusing coils to move the sensor to a second position in a third direction parallel to the optical axis,
wherein the sensor is in the neutral position when no current is applied to each stabilization coil of the plurality of stabilization coils and each focusing coil of the plurality of focusing coils.
